(19) United States
(12) Patent Application Publication
(10) Pub. No.: US 2013/0026398 A1
(43) Pub. Date: Jan. 31, 2013

(54) METHOD AND DEVICE FOR PRODUCING CONTACT COPIES OF REFLECTION VOLUME HOLOGRAMS

(71) Applicant: HOLOGRAM INDUSTRIES RESEARCH GMBH, Pliening-Ottersberg (DE)

(72) Inventor: Günther Dausman, Grasbrunn (DE)

(73) Assignee: HOLOGRAM INDUSTRIES RESEARCH GMBH, Pliening-Ottersberg (DE)

(21) Appl. No.: 13/647,416

(22) Filed: Oct. 9, 2012

(30) Foreign Application Priority Data
Apr. 9, 2010 (DE) 102010014305.7

(51) Int. Cl. F16K 35/00

(52) U.S. Cl. 251/89

(57) ABSTRACT

The invention relates to a stop valve, the stop valve includes a valve body and a switch used for controlling the valve body's opening and closing, wherein, the stop valve also includes a locking structure which is used for locking the switch, the locking structure includes a locking part set on the valve body, and a locking unit set on the switch which fits the locking part, the locking unit connects with the locking part so that to lock the switch. Keep the stop valve in closed state by compressing the free end of the locking structure to force the locking end to clamp with the locking part so that locking the switch, prevent the stop valve opening accidentally caused by external force, and remove the safety hazard.

### TECHNICAL FIELD

The invention relates to valve field, especially relates to a stop valve.

### TECHNICAL BACKGROUNDS

The working principle of a stop valve is that preventing the flowing of the medium by making the sealing face of the valve plate together with that of the valve seat. In existing technology, the stop valve is in closed state under normal state, when external force is added on the switch of the valve, the valve will be opened accidentally, which could cause a potential safety hazard.

### DESCRIPTION OF THE INVENTION

In order to solve the problem of inconvenience to carry about and use, we offer a stop valve.

We offer a technological scheme to solve the problem: construct a stop valve, includes a valve body and a switch used for controlling the valve body's opening and closing, said stop valve also includes a locking structure which is used for locking the switch, said locking structure includes a locking part set on the valve body, and a locking unit set on said switch which fits said locking part, said locking unit connects with said locking part so that locking said switch.

In the invention of a stop valve, said locking unit includes a free end and a locking end hinged with said switch, making said locking end clamp with or separate with said locking part.

In the invention of a stop valve, said locking part includes a locking block set on said valve body, said locking end has a chamber used for embracing the locking block, making the locking block in or not in the chamber by compressing the free end so that lock or loosen the switch.

In the invention of a stop valve, said valve body includes the first valve body, the second valve body and the third valve body which are connected one after another, said first valve body has a inlet connection, and said third body has a outlet connection.

In the invention of a stop valve, said switch includes a hand-held end and a hinged end connected with the end of the first valve body by the first pin, the locking unit is hinged with the hinged end by the second pin.

In the invention of a stop valve, a lockpin is set on the end of said first pin which is used for preventing said first pin falling off from said first valve body, said lockpin is elastic and semi-closed.

In the invention of a stop valve, a reset spring is set on said second pin.

In the invention of a stop valve, a sliding component is set in said third valve body, the sliding component includes a sliding part and a spring sleeved on the sliding part, said sliding part has a conical end, one end of the spring is against on said conical end, the other end of said spring is against on said hinged end of said switch said hinged end rotated so that making said spring deformed and making said conical end block the opening of said outlet connection or separate with said outlet connection.

In the invention of a stop valve, a filter component is set in said first valve body.

Benefits of the stop valve: Keep the stop valve in closed state by compressing the free end of the locking structure to force the locking end to clamp with the locking part so that locking the switch, prevent the stop valve opening accidentally caused by external force, and remove the safety hazard.

### BRIEF DESCRIPTION OF THE DRAWINGS

FIG. 1 is the schematic diagram of the stop valve;

FIG. 2 is the front view of the stop valve;

FIG. 3 is the explosive view of the stop valve.

### DETAILED DESCRIPTION OF THE PREFERRED EMBODIMENTS

These and other advantages, aspects and novel features of the present invention, as well as details of an illustrated embodiment thereof, will be more fully understood from the following description and drawings, while various embodiments of the present invention have been presented by way of example only, and not limitation.

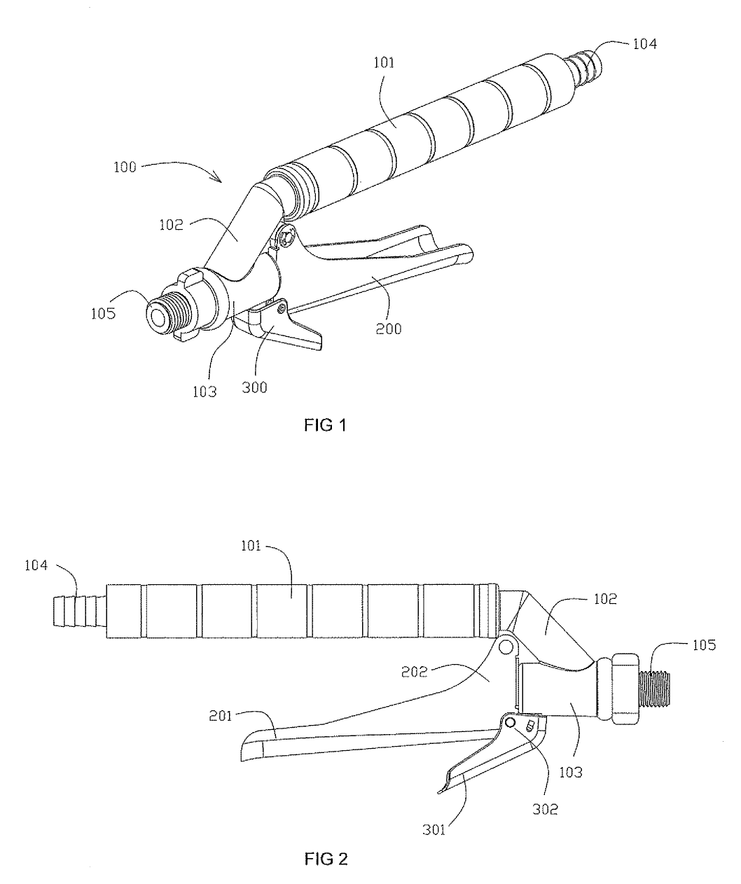

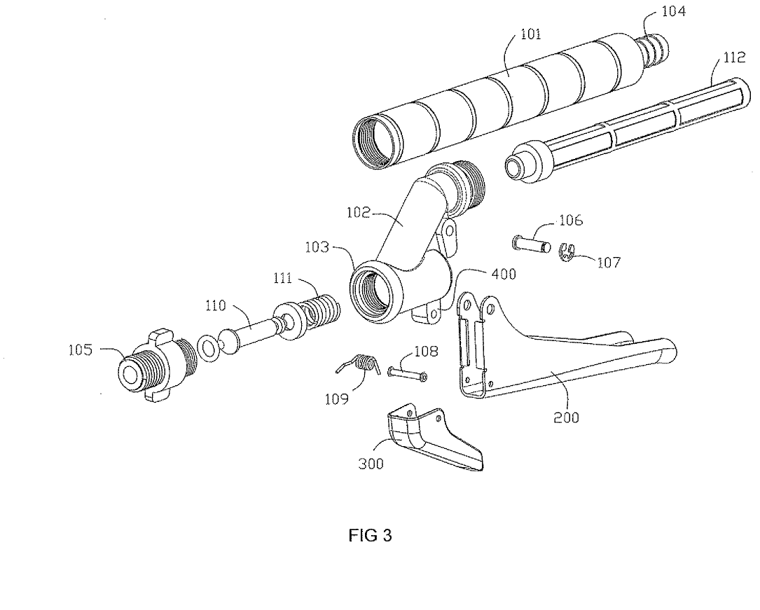

As showed in FIG. 1-3. The stop valve includes a valve body 100 and a switch 200 used for controlling the valve body 100′s opening and closing, in addition the stop valve also includes a locking structure which is used for locking the switch 200, the locking structure includes a locking part 400 set on the valve body 100, and a locking unit 300 set on the switch 200 which fits the locking part 400, the locking unit 300 connects with the locking part 400 so that to lock the switch 200. The locking unit 300 further includes a free end 301 and a locking end 302 hinged with the switch 200, make the locking end 302 clamp with or separate with the locking part 400 by compressing the free end 301. When the locking end 302 is clamped with the locking part 400, the switch is locked, hereby make sure that when the stop valve is in closed state, the stop valve will be not opened accidentally by external force. And when the locking end 302 is separated with the locking part 400, the switch is loosened.

In the preferred embodiment, the locking part 400 is a locking block set on the valve body 100, the locking end 302 has a chamber used for embracing the locking block, making the locking block in or not in the chamber by compressing the free end 301 so that lock or loosen the switch 200. It is can be seen that the locking end 302 has a curved side and a curved chamber correspondingly, the shape of the curved side and chamber match with the shape of one side of the locking block, so when the locking end 302 rotates to the position that the chamber totally embraces the locking block, the locking block can prevent the locking end 302 turning back, lock the locking end 302 and the switch 200. Which should be noted is that the structure of the locking part 400 and the locking end 302 can be other structures and should not be limited to the structure offered by the present invention, as long as the locking part 400 and the locking end 302 can clamp with each other.

The valve body 100 includes the first valve body 101, the second valve body 102 and the third valve body 103 which are connected one after another, the first valve body 101 has a inlet connection 104, and the third body 103 has a outlet connection 105. And the switch 200 includes a hand-held end 201 and a hinged end 202 connected with the end of the first valve body 101 by the first pin 106, the locking unit 300 is hinged with the hinged end 202 by the second pin 108. Besides, a lockpin 107 is set on the end of the first pin 106 which is used for preventing the first pin 106 falling off from the first valve body 101, the lockpin 107 is elastic and semi-closed. A reset spring 109 is set on the second pin 108.

There is a sliding component is set in the third valve body 103, the sliding component includes a sliding part 110 and a spring 111 sleeved on the sliding part 110, the sliding part 110 has a conical end, one end of the spring 111 is against on the conical end, the other end of the spring 111 is against on the hinged end 202 of the switch 200, compress the hand-held end 201, make the hinged end 202 rotated so that making the spring 111 deformed and making the conical end block the opening of the outlet connection 105 or separate with the outlet connection 105. On the other hand, a filter component 112 is set in the first valve body 101 which is used for filter the medium coming from the inlet connection 104.

Keep the stop valve in closed state by compressing the free end of the locking structure to force the locking end to clamp with the locking part so that locking the switch, prevent the stop valve opening accidentally caused by external force, and remove the safety hazard

1. A stop valve, includes a valve body (100) and a switch (200) used for controlling the valve body (100)'s opening and closing, said stop valve also includes a locking structure which is used for locking said switch (200), said locking structure includes a locking part (400) set on said valve body (100), and a locking unit (300) set on said switch(200) which fits said locking part (400), said locking unit (300) connects with said locking part (400) so that locking said switch (200).

2. A stop valve as in claim 1, wherein said locking unit (300) includes a free end (301) and a locking end (302) hinged with said switch (200), making said locking end (302) clamp with or separate with said locking part (400).

3. A stop valve as in claim 2, wherein said locking part (400) includes a locking block set on said valve body (100), said locking end (302) has a chamber used for embracing the locking block, making the locking block in or not in the chamber by compressing the free end (301) so that lock or loosen the switch (200).

4. A stop valve as in claim 1, wherein said valve body (100) includes the first valve body (101), the second valve body (102) and the third valve body (103) which are connected one after another, said first valve body (101) has a inlet connection (104), and said third body (103) has a outlet connection (105).

5. A stop valve as in claim 2, wherein said valve body (100) includes the first valve body (101), the second valve body (102) and the third valve body (103) which are connected one after another, said first valve body (101) has a inlet connection (104), and said third body (103) has a outlet connection (105).

6. A stop valve as in claim 3, wherein said valve body (100) includes the first valve body (101), the second valve body (102) and the third valve body (103) which are connected one after another, said first valve body (101) has a inlet connection (104), and said third body (103) has a outlet connection (105).

7. A stop valve as in claim 4, wherein said switch (200) includes a hand-held end (201) and a hinged end (202) connected with the end of the first valve body (101) by the first pin (106), the locking unit (300) is hinged with the hinged end (202) by the second pin (108).

8. A stop valve as in claim 5, wherein said switch (200) includes a hand-held end (201) and a hinged end (202) connected with the end of the first valve body (101) by the first pin (106), the locking unit (300) is hinged with the hinged end (202) by the second pin (108).

9. A stop valve as in claim 6, wherein said switch (200) includes a hand-held end (201) and a hinged end (202) connected with the end of the first valve body (101) by the first pin (106), the locking unit (300) is hinged with the hinged end (202) by the second pin (108).

10. A stop valve as in claim 7, wherein a lockpin (107) is set on the end of said first pin (106) which is used for preventing said first pin (106) falling off from said first valve body (101), said lockpin (107) is elastic and semi-closed.

11. A stop valve as in claim 8, wherein a lockpin (107) is set on the end of said first pin (106) which is used for preventing said first pin (106) falling off from said first valve body (101), said lockpin (107) is elastic and semi-closed.

12. A stop valve as in claim 9, wherein a lockpin (107) is set on the end of said first pin (106) which is used for preventing said first pin (106) falling off from said first valve body (101), said lockpin (107) is elastic and semi-closed.

13. A stop valve as in claim 7, wherein a reset spring (109) is set on said second pin (108).

14. A stop valve as in claim 8, wherein a reset spring (109) is set on said second pin (108).

15. A stop valve as in claim 9, wherein a reset spring (109) is set on said second pin (108).

16. A stop valve as in claim 7, wherein a sliding component is set in said third valve body (103), the sliding component includes a sliding part (110) and a spring (111) sleeved on the sliding part (110), said sliding part (110) has a conical end, one end of said spring (111) is against on said conical end, the other end of said spring (111) is against on said hinged end (202) of said switch (200), said hinged end (202) rotated so that making said spring (111) deformed and making said conical end block the opening of said outlet connection (105) or separate with said outlet connection (105).

17. A stop valve as in claim 8, wherein a sliding component is set in said third valve body (103), the sliding component includes a sliding part (110) and a spring (111) sleeved on the sliding part (110), said sliding part (110) has a conical end, one end of said spring (111) is against on said conical end, the other end of said spring (111) is against on said hinged end (202) of said switch (200), said hinged end (202) rotated so that making said spring (111) deformed and making said conical end block the opening of said outlet connection (105) or separate with said outlet connection (105).

18. A stop valve as in claim 9, wherein a sliding component is set in said third valve body (103), the sliding component includes a sliding part (110) and a spring (111) sleeved on the sliding part (110), said sliding part (110) has a conical end, one end of said spring (111) is against on said conical end, the other end of said spring (111) is against on said hinged end (202) of said switch (200), said hinged end (202) rotated so that making said spring (111) deformed and making said conical end block the opening of said outlet connection (105) or separate with said outlet connection (105).

19. A stop valve as in claim 4, wherein a filter component (112) is set in said first valve body (101).

20. A stop valve as in claim 5, wherein a filter component (112) is set in said first valve body (101).

21. A stop valve as in claim 6, wherein a filter component (112) is set in said first valve body (101).
